(19) United States
(12) Patent Application Publication
(10) Pub. No.: US 2012/0090905 A1
(43) Pub. Date: Apr. 19, 2012

(54) ELECTRIC DRIVE AND HEATING FOR A VEHICLE, AND METHOD FOR HEATING A VEHICLE

(75) Inventors: Dirk Vollmer, Achern (DE); Andreas Ewert, Lichtenau (DE); Markus Liedel, Pegnitz (DE); Thomas Helming, Baden-Baden (DE)

(73) Assignee: ROBERT BOSCH GMBH, Stuttgart (DE)

(21) Appl. No.: 13/144,511

(22) PCT Filed: Dec. 9, 2009
(86) PCT No.: PCT/EP09/66747

§ 371 Date: Jan. 3, 2012

(30) Foreign Application Priority Data
Jan. 14, 2009 (DE) 10 2009 000 204.9

(51) Int. Cl. B60H 1/16

(52) U.S. Cl. 180/65.1; 237/12.3 R; 432/1

(57) ABSTRACT

The invention relates to an electric drive (10, 12, 14, 16, 18) for a vehicle (1), in particular a motor vehicle. The electric drive (10, 12, 14, 16, 18) has an electric motor (10), wherein the electric motor (10) has at least one electric drive means (12, 14, 16) for producing a rotary movement. The electric drive (10, 12, 14, 16) also has a heating apparatus (20, 22, 25) which is operatively connected to the electric motor (10) and is designed to dissipate operating heat losses (34), which are produced by the electric motor (10) during production of the rotary movement, and to transfer them to a passenger compartment (26) of the vehicle (1). According to the invention, the electrical drive (10, 12, 14, 16, 18) has a control unit (16) which is connected to the electric motor (10), wherein the control unit (16) is designed to control the electric motor (10) as a function of a heating signal received on the input side such that the electric motor (10) produces additional heat losses by means of at least one of the electric drive means (12, 14, 16).

### BACKGROUND OF THE INVENTION

The invention relates to an electric drive for a vehicle, in particular motor vehicle. The electric drive has an electric motor, the electric motor having at least one electric drive means for generating a rotational movement. The electric drive also has a heating device which is operatively connected to the electric motor, and designed, in such a way as to dissipate at least operational lost heat produced by the electric motor as it generates the rotational movement and to conduct said lost heat into a passenger compartment of the vehicle.

EP 05046531 A1 discloses a method for cooling drive components and a heating arrangement of a passenger compartment of a motor vehicle, in which heat energy produced by electric drive units of the motor vehicle can be utilized to heat fresh air.

### SUMMARY OF THE INVENTION

According to the invention, the electric drive has a control unit which is connected to the electric motor and which is designed to actuate the electric motor, as a function of a heating signal received at the input side, in such a way that the electric motor produces additional lost heat by way of at least one of the electric drive means.

By means of the electric drive of the above-stated type, a total lost heat formed as a sum of the additional lost heat and the operational lost heat is advantageously greater than the operational lost heat.

The vehicle is for example a passenger motor vehicle, a heavy goods vehicle, an omnibus, a forklift truck, a tractor vehicle for pulling a trailer or an aircraft, a rail vehicle, or an aircraft.

In an advantageous embodiment of the electric drive, the electric motor is an electronically commutated electric motor, the control unit being designed to actuate the electric motor to generate a rotating field in order to generate the rotational movement. The control unit is designed to generate the rotating field such that the electric motor produces the additional lost heat. By means of the control unit of the above-stated type, it is advantageously possible for the lost heat to be produced by means of lossy actuation of drive components, for example of a stator, an armature or both, such that the auxiliary heating arrangement of the vehicle thereby formed does not require any separate components for producing the additional heat. The lossy actuation may be realized for example by means of field-oriented control.

Other advantageous embodiments for an electric motor are an asynchronous machine, a synchronous machine or a series-wound motor.

In a preferred embodiment, the control unit is designed such that, as a function of the heating signal, it connects at low impedance, or short-circuits, an electrical component of the electric drive. The electrical component of the drive is for example an armature, an armature winding, a stator coil or at least a part of a housing of the electric motor. The part of the housing may for this purpose form a heating resistance and have an ohmic resistance configured for the purpose of heating. In this way, the housing can advantageously form both a supporting structure for the stator and/or the armature and also a heating resistance.

In an exemplary embodiment of the electric drive, the electrical component is a series resistor or a suppression choke of the electric motor. In this way, it is advantageously possible for components of the electric motor which are required in any case for operating the electric motor and for generating a rotational movement to be used for the purpose of heating.

The electric drive may advantageously be a constituent part of a hybrid drive. The hybrid drive may for example have an internal combustion engine, in particular a diesel engine, a spark-ignition or a Wankel engine. The hybrid drive may also advantageously have a fuel cell connected to the electric motor of the electric drive.

The invention also relates to a vehicle having an electric drive of the above-specified type. The vehicle has a housing or at least one vehicle wall which forms a housing, the housing at least partially accommodating the electric drive and the housing having air-guiding means.

The air-guiding means are designed to guide air from the passenger compartment past the electric drive and thereby heat said air. The air-guiding means in conjunction with the correspondingly designed housing advantageously have the effect that no further separate heat exchange media, for example a cooling liquid, are required for dissipating the heat of the electric motor.

In another embodiment, a vehicle of the above-specified type may additionally have a cooling system with a liquid circuit, in particular for an air-conditioning system or for cooling an internal combustion engine, for example as a constituent part of a hybrid drive.

In one advantageous embodiment, the air-guiding means are designed and arranged so as to guide the air, which has been guided past the electric drive and heated, through under a passenger seat such that the passenger seat can be heated by means of the air heated by the electric drive.

As a result of said special design of the housing and the air-guiding means, a seat heating arrangement is advantageously formed which can heat the passenger seat, wherein in this way, no separate, for example electrical heating means are required for heating the passenger seat.

Independently of or in addition to the passenger compartment, the air-guiding means may be designed to supply the additional lost heat for heating vehicle components, for example a vehicle mirror or a vehicle window, or for charging an electrochemical converter of the vehicle component.

The invention also relates to a method for producing heat for heating a vehicle, in particular for producing heat for heating an interior space of the vehicle.

In the method, operational lost heat produced by means of an electric motor as it generates a rotational movement is dissipated and conducted into a passenger compartment. Furthermore, the electric motor is actuated, as a function of a heating signal, such that at least a part of means for generating the rotational movement of the electric motor produces additional lost heat. The additional lost heat may advantageously be provided for heating the passenger compartment. The heating signal may for example be generated by a regulator of an air-conditioning system and/or of a temperature sensor of the vehicle. In another exemplary embodiment, the heating signal is generated as a function of a user interaction, for example by the push of a button.

In one advantageous embodiment of the method, the additional lost heat is produced when the vehicle and/or the electric motor are/is at a standstill. In this way, the additional lost heat can advantageously be produced independently of or in addition to the production of the operational lost heat. It is also advantageously possible for a standstill heating arrangement to be formed in this way.

Aside from when at a standstill or during driving, the additional lost heat (38) may advantageously be produced when the electric motor (10) is operating in generator mode (54). For this purpose, it is for example possible for at least one stator winding to be connected at low impedance. The vehicle may advantageously have a defroster device, preferably a standstill heating arrangement, which is designed to preheat the vehicle for example in winter by means of the additional lost heat.

### BRIEF DESCRIPTION OF THE DRAWINGS

The invention will now be described below on the basis of the figures and further exemplary embodiments.

FIG. 1 schematically shows an exemplary embodiment of a vehicle having an electric drive which is designed to produce additional lost heat as a function of a heating signal;

FIG. 2 shows an exemplary embodiment of two Sankey diagrams illustrating the mode of operation of the electric drive illustrated in FIG. 1.

### DETAILED DESCRIPTION

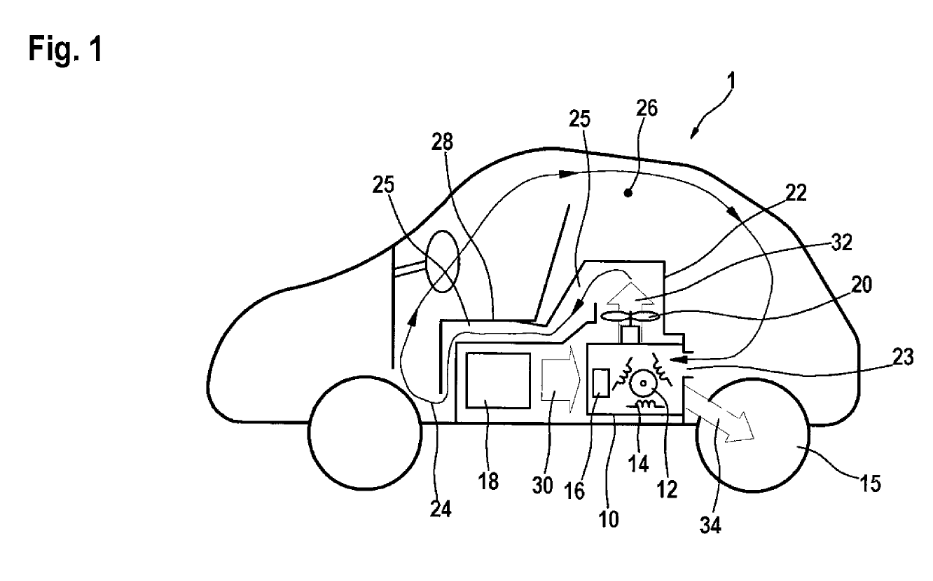

FIG. 1 shows a vehicle 1. The vehicle 1 has an electric drive. The electric drive has an electric motor 10 and also a battery 18 which is connected to the electric motor 10 in order to provide a supply of electricity to the electric motor 10.

The electric motor 10 has an armature 12 and stator coils, of which the stator coil 14 is labeled by way of example. The armature is designed to generate a rotational movement, for propelling the vehicle 1, as a function of a magnetic rotating field generated by the stator coils 14 of the electric motor. The vehicle 1 also has wheels, of which one wheel 15 is labeled by way of example. The electric motor is connected to at least some of the wheels 15 and is designed to set the wheels 15 in rotational motion and thereby propel the vehicle 1.

The electric motor 10 also has a control unit 16. The control unit 16 is designed to actuate the stator coils 14 such that the magnetic rotating field can be generated by means of the stator coils 14.

The vehicle 1 also has a housing 22. The housing 22 is designed to at least partially, in this exemplary embodiment completely, accommodate the electric drive comprising the battery 18 and the electric motor 10. The housing 22 has air-guiding means designed to guide air from a passenger compartment 26 of the vehicle 1 past the electric drive, in particular the electric motor 10, and heat the air. In this exemplary embodiment, the air-guiding means comprise an intake duct 23 which is arranged such that the air from the passenger compartment 26 can be guided past components of the electric motor 10, in particular the armature 12, the stator coils 14 and the control unit 16. The air-guiding means also comprise a fan 20 which is designed and arranged so as to guide the air which has been heated by the electric motor 10, in particular by the components of the electric motor 10, from the passenger compartment 26 via a flow duct 25 under or through a passenger seat 28, such that the passenger seat 28 can be heated by means of the heated air. The air volume flow 24 then flows onward in the region of a footwell of the passenger compartment 26 and back into the passenger compartment 26. The air volume flow 24 may, in addition to or independently of the fan, be assisted by a relative wind. For this purpose, the vehicle may have at least one opening which is exposed to the relative wind and through which outside air can be conducted to the electric drive, in particular the electric motor 10. The fan 20 may be driven by the electric motor 10 or may have a separate drive motor. If drive is provided by the electric motor 10, an armature shaft of the armature 12 may drive the fan. The fan may be for example an axial or radial fan.

The radial fan is advantageously formed by the armature 12 which, for this purpose, has for example guide blades designed to generate the air volume flow.

In an advantageous embodiment, the electric motor has thermal insulation such that unutilized heat loss to a vehicle environment is reduced—in relation to the use of no insulation. The heating arrangement may be designed to dissipate the operational lost heat to the vehicle environment if there is no demand for heat for heating purposes, such that the electric motor advantageously cannot overheat.

The control unit 16 is designed to generate the rotating field for generating the rotational movement of the armature 12 as a function of a heating signal—generated for example by an air-conditioning system of the vehicle 1 or by a user, for example a passenger—such that additional lost heat is produced while the rotational movement is being generated, which additional lost heat can be transported by means of the fan 20 together with operational lost heat—produced by the stator coils 14, the armature 12 and the control unit 16—into the passenger compartment 26 by means of the air volume flow 24.

The electric motor 10 generates drive energy which, as part of a total energy 30 output by the battery 18, can serve for driving the wheel 15 in rotation. A part of the total energy complementary to the drive energy is available, in the form of operational lost heat 32, for heating the passenger compartment 26.

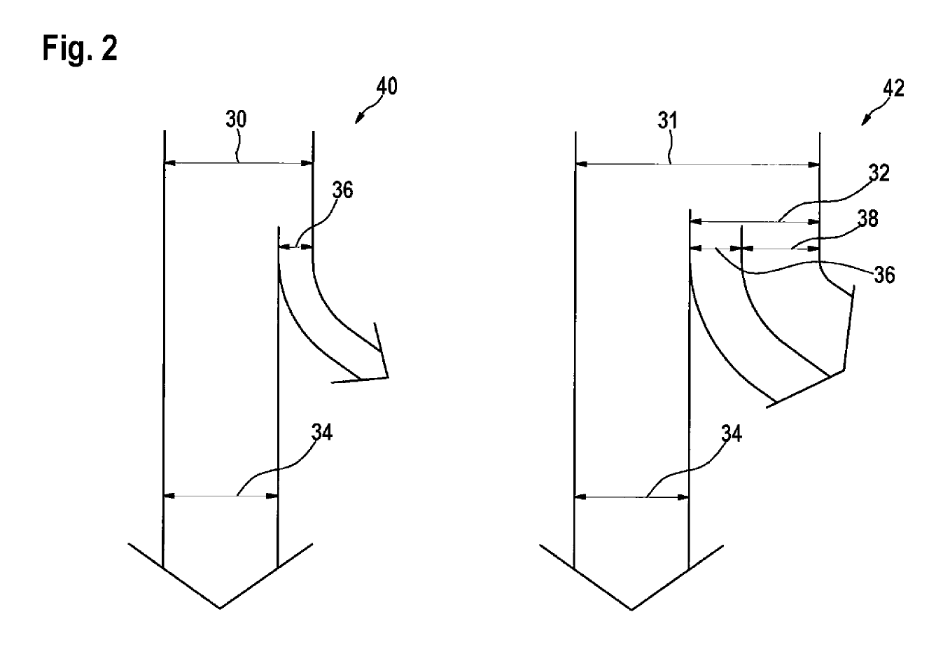

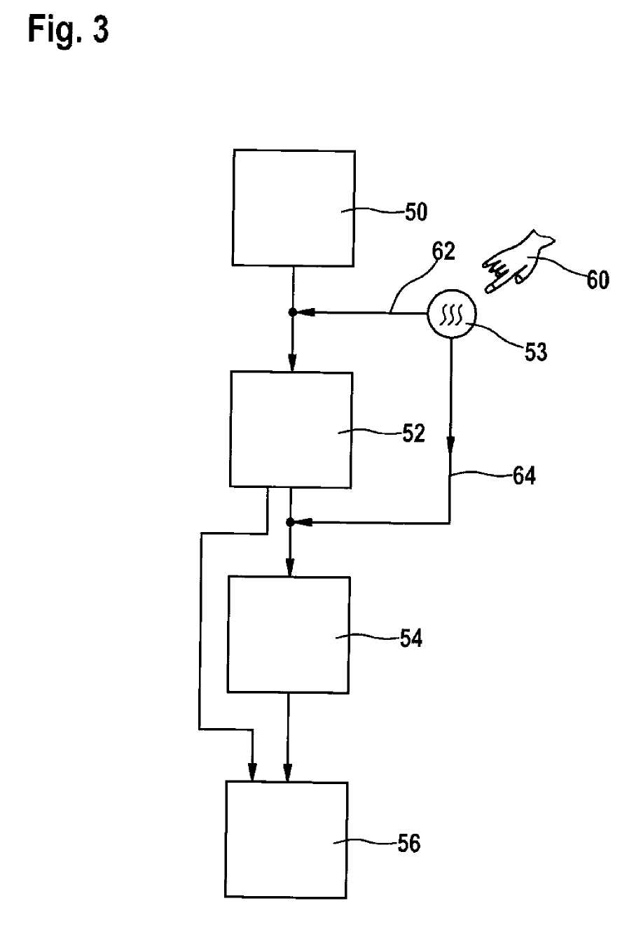

FIG. 2 schematically shows two Sankey diagrams, specifically a Sankey diagram 40 and a Sankey diagram 42. The Sankey diagram 40 shows an energy flow in which a fraction of a total energy 30 is converted into drive energy 34 for operating the electric drive described in FIG. 1, and here, operational lost heat 36—produced by the electric drive—is produced in addition to the generated drive energy 34 in the form of rotational energy.

Also illustrated is a Sankey diagram 42. The Sankey diagram 42 shows a total energy 31 which is extracted from the battery 18 illustrated in FIG. 1 in the form of electrical energy in order to provide a supply to the electric drive of the vehicle 1 illustrated in FIG. 1. The battery 18 may for example be a fuel cell, a lead-acid storage battery, a sodium-sulfur battery or a lithium-ion storage battery. The electric drive of the vehicle 1 converts at least a part of the total energy 31 into drive energy, in particular rotational energy, by means of which the vehicle 1 can be propelled.

Aside from the drive energy 34, the electric drive produces a total lost heat 32. The total lost heat 32 is divided into operational lost heat 36, the operational lost heat 36 corresponding to the operational lost heat 36 in the Sankey diagram 40. The operational lost heat 36 is generated in this exemplary embodiment during normal operation of the electric motor 10 when no additional heat energy is required for heating the vehicle 1. The Sankey diagram 42 shows additional lost heat 38 as part of the total lost heat 32. The additional lost heat 38 is produced by the electric drive illustrated in FIG. 1—in addition to or independently of the operational lost heat 36—as a function of the heating signal.

The operational lost heat 36 amounts to for example 15 percent of the total energy 30. The drive energy 34 then amounts to 85 percent of the total energy 30.

FIG. 3 shows an exemplary embodiment of a method for producing heat for heating a vehicle interior space of a motor vehicle. In the method, in a method step 50, operational lost heat produced by an electric motor as it generates a rotational movement is dissipated. If there is a demand for heating, the operational lost heat is conducted into a passenger compartment.

In a method step 52, as a function of a heating signal 53, the electric motor is actuated via a connecting path 62 such that at least a part of drive means of the electric motor for generating the rotational movement produces additional lost heat. The heating signal is produced for example as a function of a user interaction 60—or by means of a regulator of an air-conditioning system.

In a method step 54, the additional lost heat is produced as a function of the heating signal 53 independently of the production 52 of operational lost heat—for example when the electric motor is at a standstill. This is illustrated by a connecting path 64. The independent production of operational lost heat may advantageously take place by connecting at least one drive component, for example a stator coil or the armature of the electric motor, at low impedance. The method then starts in the method step 54, triggered by the heating signal 53.

The additional lost heat may be realized independently of or in addition to the lossy generation of the rotating field, for example by connecting at least one drive component at low impedance.

When the vehicle is at a standstill, the operational lost heat is zero. A total lost heat formed from the operational lost heat and the additional lost heat is then formed by the additional lost heat.

In a method step 56, the additional lost heat is provided for heating the passenger compartment.

1. An electric drive (10, 12, 14, 16, 18) for a vehicle (1), an electric motor (10) having at least one electric drive means (12, 14, 16) for generating a rotational movement, and having a heating device (20, 22, 25) which is operatively connected to the electric motor, and designed, in such a way as to dissipate operational lost heat (34) produced by the electric motor (10) as it generates a rotational movement and to conduct said lost heat into a passenger compartment (26) of the vehicle (1), characterized in that the electric drive (10, 12, 14, 16, 18) has a control unit (16) which is connected to the electric motor (10) and which is designed to actuate the electric motor (10) in such a way that the electric motor (10) produces additional lost heat (38) by way of at least one of the electric drive means (12, 14, 16).

2. The electric drive (10, 12, 14, 16, 18) as claimed in claim 1, characterized in that the electric motor (10) is an electronically commutated electric motor and the control unit (16) is designed to actuate the electric motor (10) to generate a rotating field in order to generate the rotational movement, the control unit (16) being designed to generate the rotating field such that the electric motor (10) produces the additional lost heat (38).

3. The electric drive (10, 12, 14, 16, 18) as claimed in claim 1, characterized in that the control unit (16) is designed such that, as a function of the heating signal (53), it connects at low impedance, or short-circuits, an electrical component (12, 14) of the electric drive.

4. The electric drive as claimed in claim 3, characterized in that the electrical component is an armature winding (12) of the electric motor (10).

5. The electric drive (10, 12, 14, 16, 18) as claimed in claim 3, characterized in that the electrical component is a series resistor of the electric motor (10).

6. The electric drive (10, 12, 14, 16, 18) as claimed in claim 1, characterized in that the electric drive (10, 12, 14, 16, 18) is a constituent part of a hybrid drive.

7. A vehicle (1) having an electric drive (10, 12, 14, 16, 18) as claimed in claim 1, characterized in that the vehicle (1) has a housing (22) which at least partially accommodates the electric drive (10, 12, 14, 16, 18) and the housing (22) has air-guiding means (25) designed to guide air from the passenger compartment (26) past the electric drive (10, 12, 14, 16, 18) and thereby heat said air.

8. The vehicle (1) having an electric drive (10, 12, 14, 16, 18) as claimed in claim 7, characterized in that the air-guiding means (25) are designed and arranged so as to guide the air, which has been guided past the electric drive (10, 12, 14, 16, 18) and heated, through or under a passenger seat (28) such that the passenger seat is heated.

9. A method (50, 52, 56) for producing heat for heating a vehicle, in which operational lost heat (32) produced by means of an electric motor (10) as it generates a rotational movement is dissipated and conducted into a passenger compartment (26), characterized in that the electric motor (10) is actuated, such that at least a part of means of the electric motor (10) for generating the rotational movement produces additional lost heat (38).

10. The method (50, 54, 56) as claimed in claim 9, characterized in that the additional lost heat (38) is produced when the electric motor (10) and the vehicle are at a standstill (54).

11. The method (50, 54, 56) as claimed in claim 9, characterized in that the additional lost heat (38) is produced when the electric motor (10) is operating in a generator mode (54).

12. The electric drive (10, 12, 14, 16, 18) as claimed in claim 1, characterized in that the electric motor (10) is actuated as a function of a heating signal (53) received by the control unit (16).

13. The electric drive as claimed in claim 3, characterized in that the electrical component is a-stator coil (14) of the electric motor (10).

14. The electric drive (10, 12, 14, 16, 18) as claimed in claim 3, characterized in that the electrical component is a suppression choke of the electric motor (10).

15. The method (50, 54, 56) as claimed in claim 9, characterized in that the electric motor (10) is actuated as a function of a heating signal (53).

16. The method (50, 54, 56) as claimed in claim 9, characterized in that the additional lost heat (38) is produced when the electric motor (10) is at a standstill (54).

17. The method (50, 54, 56) as claimed in claim 9, characterized in that the additional lost heat (38) is produced when the vehicle is at a standstill (54).
